(19) United States
(12) Patent Application Publication
(10) Pub. No.: US 2026/0279701 A1
(43) Pub. Date: Sep. 17, 2026

(54) PUSH-BUTTON ARRANGEMENT FOR A GAMING MACHINE AND A GAMING MACHINE

(71) Applicant: Veikkaus Oy, Helsinki (FI)

(72) Inventor: Jukka LEHTONEN, Vantaa (FI)

(21) Appl. No.: 18/877,182

(22) PCT Filed: Jun. 19, 2023
(86) PCT No.: PCT/FI2023/050363

§ 371 Date: Dec. 19, 2024

(30) Foreign Application Priority Data
Jun. 20, 2022 (FI) 20225550

(51) Int. Cl. H01H 13/52; G07F 17/32

(52) U.S. Cl. CPC H01H 13/52; G07F 17/3209; G07F 17/3211; H01H 2013/525

(57) ABSTRACT

The push-button arrangement for a gaming machine includes a push-button panel including an opening for receiving a push-button, a push-button arranged in the opening and having a rest position and a pushed position, a push detector configured to detect moving of the push-button to the pushed position, and at least two bendable spring elements having a fixed end attached to the push-button panel and a free end, where a force exerted on the free end causes bending of the spring element. The arrangement is configured such that pushing of the push-button from the rest position to the pushed position exerts a force on the free ends of the spring elements, and the spring elements are configured to push the push-button back to the rest position when the push-button is released.

### TECHNICAL FIELD OF THE INVENTION

The present invention relates to a push-button arrangement for a gaming machine, as defined in claim 1. The invention also concerns a gaming machine.

### BACKGROUND OF THE INVENTION

Different gaming machines, sometimes referred to as electronic gaming machines (EGM), are a popular form of entertainment. Gaming machines can be placed in casinos or gambling halls that are dedicated to gambling, but also in grocery stores, gas stations, restaurants and other places.

Lots of different kind of gaming machines are known. The operation of most gaming machines is nowadays based on software running on a computer, which allows offering in a single gaming machine several different gaming options to a user, or updating the machine from time to time. Such gaming machines can be operated using a touch display, which allows the user interface to be easily configured for different games. However, the gaming experience provided by touch displays significantly differs from the experience provided by mechanical push-buttons. Many users of the gaming machines prefer the feeling of mechanical push-buttons.

A drawback of mechanical push-buttons is that they typically allow only a single type of action. Also, the mechanical push-buttons require a certain space in the moving direction of the push-button, which sets requirements for the design of the gaming machine. Furthermore, mechanical push-buttons are difficult to configure for different uses.

### SUMMARY OF THE INVENTION

An object of the present invention is to provide an improved push-button arrangement for a gaming machine. The characterizing features of the push-button arrangement according to the invention are defined in claim 1. Another object of the invention is to provide an improved gaming machine.

The push-button arrangement according to the invention comprises a push-button panel comprising at least one opening for receiving a push-button, a push-button arranged in the at least one opening of the push-button panel and having a rest position and at least one pushed position, push detection means configured to detect moving of the push-button to the at least one pushed position, and at least two bendable spring elements, each spring element having a fixed end that is attached directly or indirectly to the push-button panel and a free end, wherein a force exerted on the free end in a direction that is perpendicular to the plane of the push-button panel causes bending of the spring element. The arrangement is configured such that pushing of the push-button from the rest position to the at least one pushed position exerts a force on the free ends of the spring elements such that the spring elements are bent, and the spring elements are configured to push the push-button back to the rest position when the push-button is released.

The bendable spring elements enable a slim structure of the push button arrangement, where the thickness is determined largely by the type of the push detection means and the desired moving distance of the push-button. The push-button arrangement is easy to configure for different uses by changing the properties of the spring elements. Also, the push-button arrangement can be easily configured to allow multiple functions of the push-button.

According to an embodiment of the invention, the spring elements are part of a spring plate. The spring plate simplifies assembly of the push-button arrangement.

According to an embodiment of the invention, the arrangement comprises at least four spring elements. In case of a substantially rectangular push-button, the spring elements are preferably arranged close to the corners of the push-button. Preferably, the spring elements are arranged symmetrically about the push-button. This prevents pulling of the push-button to the sides and allows using large push-buttons and minimizing the gap between the push-button and the push-button panel.

According to an embodiment of the invention, the spring elements are made of steel. In case of a spring plate, the plate can thus be a steel plate. The plate can be made of spring steel. The thickness of the steel plate can be, for instance, in the range of 0.1-0.4 mm. The use of steel thus allows making the construction very low. However, also other materials could be used in the spring elements or spring plate. Examples of suitable materials include bronze, titanium, different plastic materials, cobalt-nickel and different composites.

According to an embodiment of the invention, the free end of one or more of the spring elements comprises an opening and the push-button comprises a guide element protruding through the opening to limit movement of the push-button in the direction of the plane of the push-button panel. This allows having even smaller tolerances between the push-button and the push-button panel.

According to an embodiment of the invention, the push detection means comprise at least one electrical switch. The electrical switch can be configured to be switched on when the push-button reaches the pushed position.

According to an embodiment of the invention, the push detection means comprise at least one microswitch and pushing of the push-button is configured to push the microswitch in a direction that is parallel to the plane of the push-button panel. This allows using standard components and by arranging the microswitch such that it is pushed in the direction of the plane of the push-button panel, the construction can be kept low.

According to an embodiment of the invention, at least one of the spring elements is configured to form part of an electrical switch functioning as the push detection means. By using the spring element as part of the electrical switch, the construction can be made even lower than with microswitches. If the spring element is not made of an electrically conductive material, it can be provided with an electric conductor, or it could be at least partly coated with an electrically conductive material.

According to an embodiment of the invention, the push detection means comprise a touch detection surface arranged below the push-button and at least one contact element configured to contact the touch detection surface when the push-button is in the at least one pushed position. The touch detection surface provides similar benefits as the use of the spring elements as parts of electrical switches. The at least one contact element can be attached to one of the spring elements.

According to an embodiment of the invention, the push detection means comprise a touch-sensitive surface arranged below the push-button.

According to an embodiment of the invention, the push detection means comprise a touch display arranged below the push-button. A touch display could be simultaneously used for displaying information through a transparent push-button.

According to an embodiment of the invention, the push detection means are configured to detect which area of the push-button is pressed. This allows using several functions of the gaming machine with a single push-button.

According to an embodiment of the invention, the push-detection means comprise at least two electrical switches or at least two touch detection areas and switching of the states of the electrical switches or touching of the touch detection areas is configured to depend on which area of the push-button is pressed.

A gaming machine according to the invention comprises a push-button arrangement defined above.

### BRIEF DESCRIPTION OF THE DRAWINGS

Embodiments of the invention are described below in more detail with reference to the accompanying drawings, in which

FIG. 1 shows an example of a gaming machine with a push-button arrangement according to an embodiment of the invention,

FIG. 2 shows a perspective front view of a push-button panel of a gaming machine,

FIG. 3 shows a perspective rear view of the push-button panel of FIG. 2,

FIG. 4 shows an exploded view of the push-button panel of FIGS. 2 and 3,

FIG. 5 shows an enlarged view of detail A of FIG. 4,

FIG. 6 shows an enlarged view of detail B of FIG. 4,

FIG. 7 shows a rear view of the push-button panel of FIGS. 2 and 3,

FIG. 8 shows a cross-sectional view of the push-button panel of FIG. 7 taken along line A-A,

FIG. 9 shows a cross-sectional view of the push-button panel of FIG. 7 taken along line B-B,

FIG. 10 shows an enlarged view of detail C of FIG. 8,

FIG. 11 shows an enlarged view of detail D of FIG. 9,

FIG. 12 shows a detail of a push-button arrangement according to an embodiment of the invention,

FIG. 13 shows a perspective rear view of a push-button arrangement according to another embodiment of the invention,

FIG. 14 shows the push-button arrangement of FIG. 13 without a rear cover,

FIG. 15 shows a similar view as FIG. 14,

FIG. 16 shows a cross-sectional view taken along line C-C of FIG. 15,

FIG. 17 shows an enlarged view of detail E of FIG. 16,

FIG. 18 shows a perspective rear view of a push-button arrangement according to a further embodiment of the invention,

FIG. 19 shows an enlarged view of detail F of FIG. 18,

FIG. 20 shows a cross-sectional view of the push-button arrangement of FIG. 18,

FIG. 21 shows a rear view of the push-button arrangement of FIG. 18,

FIG. 22 shows a cross-sectional view taken along line D-D of FIG. 21, and

FIG. 23 shows an enlarged view of detail G of FIG. 22.

### DETAILED DESCRIPTION OF EMBODIMENTS OF THE INVENTION

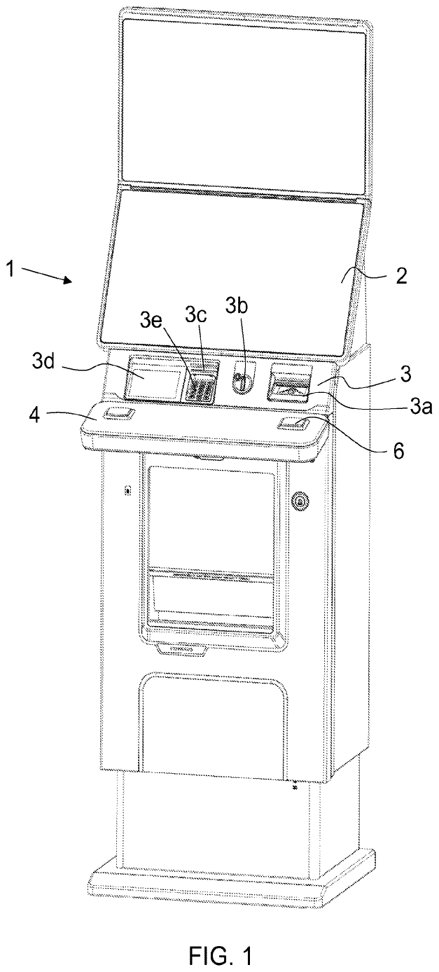

FIG. 1 shows an example of a gaming machine 1. In the example of FIG. 1, the gaming machine 1 comprises a display 2, on which the games that can be played are displayed. Instead of, or in addition to the display 2, the gaming machine 1 could comprise electromechanical components, such as rotating wheels that are used for implementing the games. The gaming machine 1 is configured for playing games of change, such as different card games or slot machine type games.

The gaming machine 1 comprises a payment terminal 3, via which the user of the gaming machine 1 can pay for the played games. In the example of FIG. 1, the payment terminal 3 comprises a slot 3a for banknotes, a coin slot 3b and a card reader 3c. The payment terminal 3 further comprises a keypad 3e, for instance for inputting a pin code of a debit or credit card, and a display 3d. The payment terminal 3 does not need to comprise all the features listed above, but the available payment methods could be limited. Also, the payments could be implemented for example via bank transfers carried out using a keyboard or a touch display of the gaming machine 1 or using a mobile device of the user of the gaming machine 1. The payment terminal 3 is thus not an essential part of the gaming machine 1.

The gaming machine 1 further comprises a push-button panel 4. In the example of FIG. 1, the push-button panel 4 comprises two push-buttons 6. However, the push-button panel 4 could comprise a single push-button 6 or more than two push-buttons 6. The games provided in the gaming machine 1 can be played using the one or more push-buttons 6. However, it is possible to configure the gaming machine 1 such that only some games are played using the push-buttons 6 arranged in the push-button panel 4 and/or that the games are played only partly using the push-buttons 6 of the push-button panel 4. The gaming machine 1 could comprise further push-button panels 4 and/or some functions of the gaming machine 1 could be used via a touch display or other input means. In the example of FIG. 1, the push-button panel 4 has a planar outer surface. However, the push-button panel 4 could also be curved. The push-button panel 4 could be located differently in the gaming machine 1.

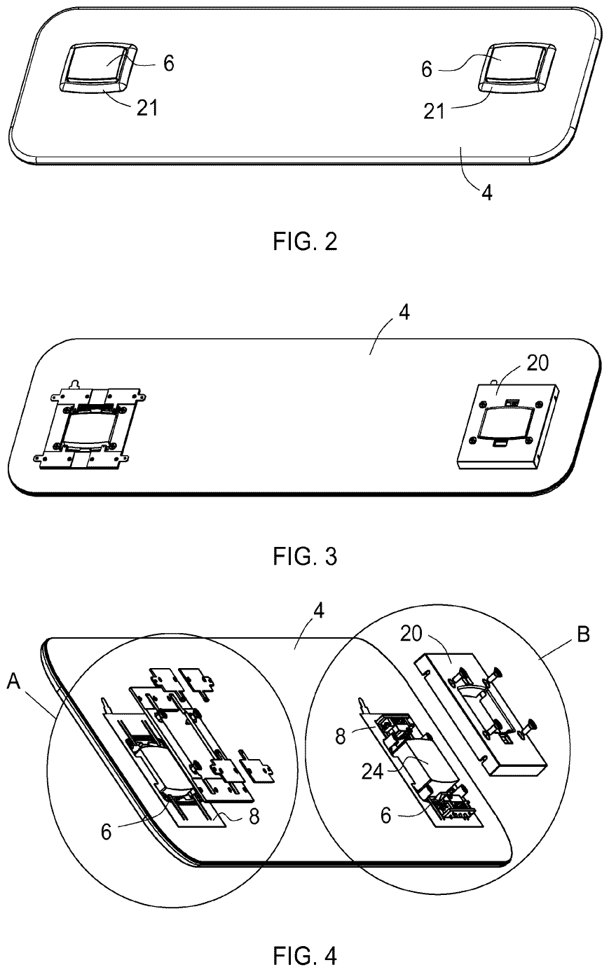

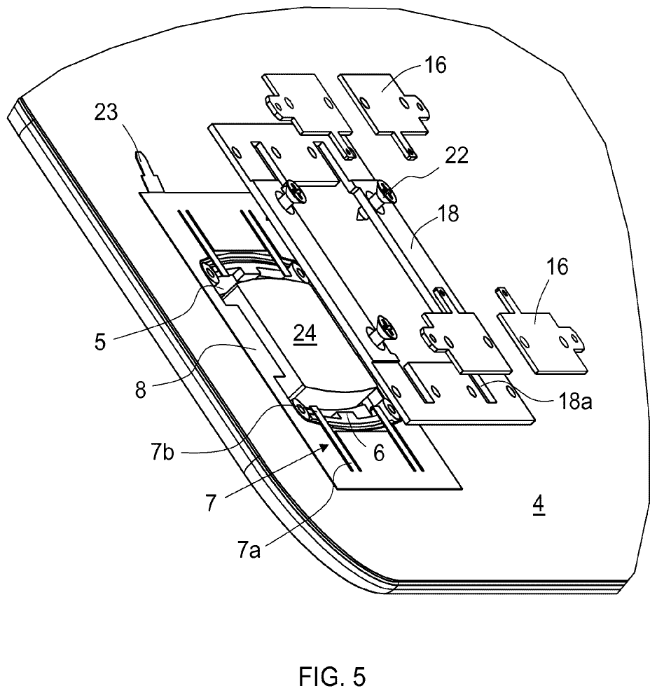

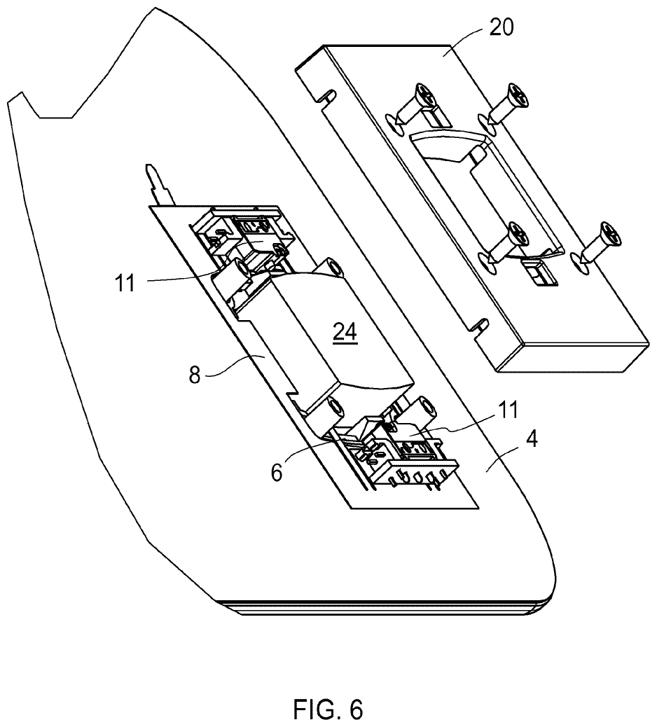

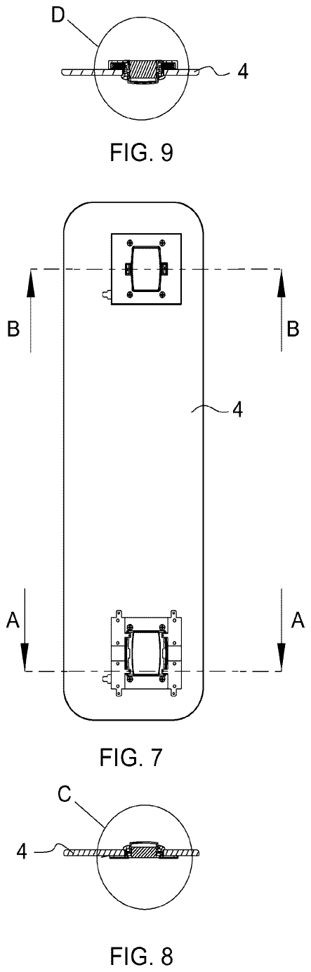

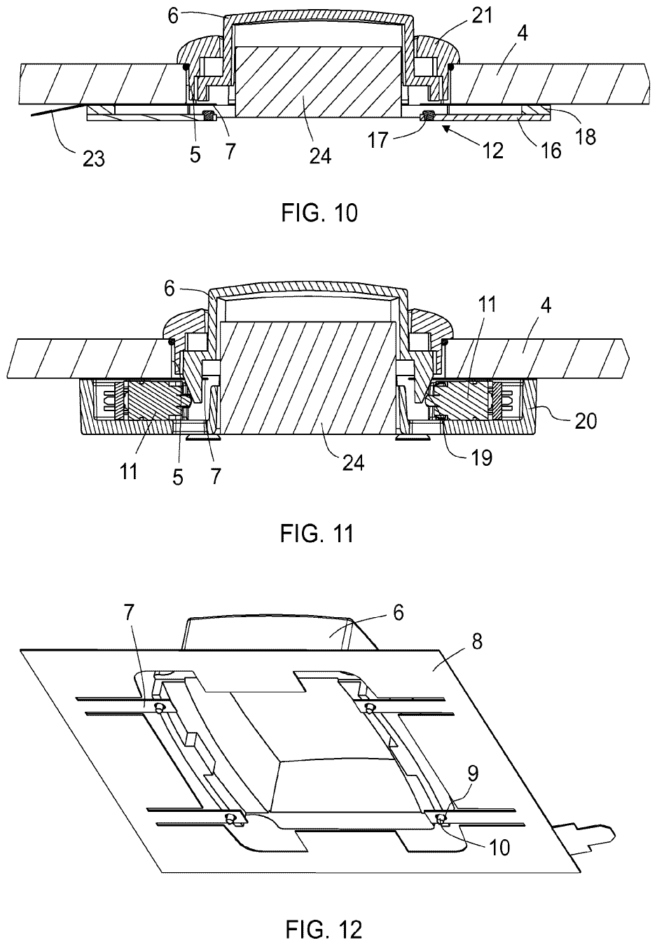

FIG. 2 shows a perspective front view of a push-button panel 4. FIG. 3 shows a perspective rear view of the same push-button panel 4. The push-button panel 4 is provided with two push-buttons 6. FIGS. 2 and 3 show push-button arrangements according to two different embodiments of the invention. In FIG. 4, detail A shows a push-button arrangement according to a first embodiment of the invention and detail B shows a push-button arrangement according to a second embodiment of the invention. Further details of the first embodiment can be seen in FIGS. 5, 8 and 10 and further details of the second embodiment can be seen in FIGS. 6, 9 and 11.

A single push-button panel 4 can be part of two or more push-button arrangements. The push-button arrangements can be identical with each other or they can differ from each other, as in the figures.

In all the embodiments of the invention, the arrangement comprises a push-button panel 4 comprising at least one opening 5 for receiving a push-button 6. The push-button 6 is arranged in the at least one opening 5 of the push-button panel 4 and has a rest position and at least one pushed position. The rest position refers to the position where the push-button 6 is not being pressed.

The arrangement further comprises push detection means configured to detect moving of the push-button 6 to the at least one pushed position, and at least two bendable spring elements 7, each spring element 7 having a fixed end 7a that is attached directly or indirectly to the push-button panel 4 and a free end 7b, wherein a force exerted on the free end 7b in a direction that is perpendicular to the plane of the push-button panel 4 causes bending of the spring element 7.

The arrangement is configured such that pushing of the push-button 6 from the rest position to the at least one pushed position exerts a force on the free ends 7b of the spring elements 7 and the spring elements 7 are configured to push the push-button 6 back to the rest position when the push-button 6 is released.

In the embodiments of the figures, the push-button panel 4 is planar. When the push-button 6 is in the rest position, the spring elements 7 are parallel to the plane of the push-button panel 4. However, the push-button panel 4 does not need to be planar and the spring elements 7 do not need to be parallel to the plane of the push-button panel 4. For example, the push-button panel 4 could be slightly curved about one or two axes. Also, in the rest position of the push-button 6, the spring elements 7 could be bent to create for the push-button 6 a biasing force towards the rest position. The spring elements 7 could be made flat and the push-button 6 could be configured to bend the spring elements 7 in the rest position towards the pushed position. Alternatively, the spring elements 7 could be made curved for pressing the push-button 6 in the rest position to create a biasing force.

The rest position of the push-button 6 is thus a position where the push-button 6 is not pushed. When a user of the gaming machine 1 pushes the push-button with a sufficient force, the push-button 6 moves against the spring force of the spring elements 7 to the pushed position, where the push detection means can detect that the push-button 6 has been pushed. When the push-button 6 is released, the spring elements 7 push the push-button 6 back to the rest position. The push-button 6 can have more than one pushed positions. For instance, if an edge area of the push-button 6 is pressed, the pressed area of the push-button 6 could move more than an opposite edge area or reach the pushed position before the opposite edge, and the push detection means could detect that part of the push-button 6 has moved to a pushed position. Also, the push detection means could be configured to detect that the push-button 6 has moved only over part of the distance between the rest position and a fully pushed position.

In the embodiments of the figures, the spring elements 7 are elongated, strip-like elements. In the embodiments of the figures, each spring element 7 has a constant width. However, the spring elements 7 could also have a different shape. In the embodiments of the figures, all the spring elements 7 are identical with each other. However, the push-button arrangement could comprise different spring elements 7. Preferably, the spring elements 7 are arranged symmetrically about the push-button 6.

The spring elements 7 can be made of steel, such as spring steel. In the embodiments of the figures, the spring elements 7 are part of a spring plate 8. The spring plate 8 surrounds the opening 5 of the push-button panel 4. In the embodiments of the figures, all the spring elements 7 are part of the same spring plate 8. However, the spring elements 7 could also be arranged in two or more spring plates 8. The thickness of the spring plate 8, or in case of separate spring elements 7, the thickness of the spring elements 7, can be for example in the range of 0.1-0.4 mm. By varying the thickness and/or the dimensions of the spring elements 7 or the spring plate 8, the characteristics and the user experience of the push-button arrangement can be changed even without modification of the other parts of the push-button arrangement.

Instead of steel, also other materials could be used in the spring elements 7 or the spring plate 8. Examples of suitable materials include bronze, titanium, different plastic materials, cobalt-nickel and different composite materials. If the spring elements 7 are made of some other material than steel, the suitable thickness range of the spring elements 7 may be different.

The spring plate 8 is attached to the lower side of the push-button panel 4. The expression “lower side” refers here to the inner side of the push-button panel 4, i.e. the side facing away from the user of the gaming machine 1 in a use position of the push-button arrangement. In the embodiment of FIG. 1, the push-button panel 4 is not horizontal, but arranged at an angle of approximately 20 degrees relative to the horizontal direction. The push-button panel 4 could be even vertical.

In the embodiments of the figures, there are four spring elements 7 for each push-button 6. However, there could also be only two spring elements 7 for each push-button 6, for instance on opposite sides of the push-button 6, three spring elements 7, or more than four spring elements 7.

In the embodiments of the figures, the push-button 6 is substantially rectangular seen in a direction that is perpendicular to the plane of the push-button panel 4. However, the push-button 6 could also have some other shape. The push-button 6 could be, for instance, circular or triangular. A push-button arrangement with a triangular push-button could be provided with three spring elements 7. In a push-button arrangement with a circular push-button 6, the spring elements 7 could be arranged evenly spaced along the circumference of the push-button 6. Especially with a large push-button 6, the push-button arrangement could comprise more than four spring elements 7.

On the upper side of the push-button panel 4, i.e. on the outer side, the arrangement is provided with a push-button frame 21. The push-button frame 21 surrounds the push-button 6 and it is configured to retain the push-button 6 between the spring elements 7 and the push-button frame 21. The push-button frame 21 can be attached to the push-button panel 4 for instance by snap-on connections or gluing. The push-button frame 21 is not necessary, but the push-button arrangement could be configured to work also without the frame 21. For instance, the push-button 6 could be provided with a flange or protrusions extending below the push-button panel 4 beyond the push-button opening 5.

In the first embodiment of the invention, the push detection means comprise an electrical switch 12. The electrical switch 12 has an off-state and an on-state. When the push-button 6 is in the rest position, the electrical switch 12 is in the off-state. When the push-button 6 is moved to the pushed position, the electrical switch 12 is switched from the off-state to the on-state. When the push-button 6 is released and it returns to the rest position, the electrical switch 12 is switched from the on-state back to the off-state.

In the first embodiment, the push-button arrangement comprises four electrical switches 12. Each spring element 7 forms part of an electrical switch 12. Each electrical switch 12 further comprises a contact element 16, which is in the embodiment of the figures a contact plate. An insulation plate 18 is arranged between the spring plate 8 and the contact plates 16. In the embodiment of the figures, the insulation plate 18 is also used as attachment means for the spring plate 8. The insulation plate 18 is attached by means of screws 22 to the push-button panel 4 and the spring plate 8 is clamped between the insulation plate 18 and the push-button panel 4. However, the spring plate 8 could also be attached to the push-button panel 4 in a different way and also the contact elements 16 could thus be insulated from the spring plate 8 in a different way.

The spring plate 8 is provided with an electrical contact 23. Also each of the contact elements 16 is provided with an electrical contact. As the push-button 6 is pushed to the pushed position, the spring elements 7 come into contact with the contact plates 16. The electrical switches 12 formed by the contact elements 16 and the spring elements 7 are thus switched from an off-state to an on-state, which indicates that the push-button 6 is in the pushed position.

In the embodiment of the figures, the insulation plate 18 is provided with cutouts 18a that allow the spring elements 7 to contact the contact elements 16 when the push-button 6 is pushed. However, the insulation plate 18 could be configured also in many other ways. Also, the insulation plate 18 is not necessary, but the contact elements 16 could be attached to the push-button panel 4 in a different way.

The push-button arrangement could be provided with a single contact element 16. The contact element 16 could be dimensioned such all the spring elements 7 come into contact with the contact element 16 as the push-button 6 is moved to the pushed position. This would provide a reliable arrangement, as it would be sufficient that even one of the spring elements 7 contact the contact element 16 in case the push-button 6 is pressed unevenly. However, the contact element 16 could be dimensioned to contact only one of the spring elements 7. By providing each of several contact elements 16 with an own electrical contact, it is possible to detect how the push-button 6 has been pressed. For instance, if a corner area of the push-button 6 is pressed, one of the electrical switches 12 may be switched on before the other electrical switches 12, or some of the electrical switches 12 may not be switched on, indicating that the push-button 6 was pressed unevenly. That would allow having several functions in a single push-button 6.

In the embodiment of the figures, the contact elements 16 are provided with raised portions 17 that are configured to enhance the contact with the spring elements 7.

In the embodiment of the figures, the spring plate 8 is made of steel. The spring elements 7 are thus electrically conductive and current can be conducted through the spring elements 7. However, the spring elements 7 could be used as part of the electrical switches 12 even in case the spring plate 8 was made of an electrically non-conductive material. In that case, the spring elements 7 could be at least partly coated with an electrically conductive material. Alternatively, or in addition, the spring elements 7 could be provided with electrical conductors.

Also in the second embodiment of the invention, the push-button arrangement comprises an electrical switch. However, in the second embodiment, the electrical switch is a microswitch 11. In the embodiment of the figures, the push-button arrangement comprises two microswitches 11. The microswitches 11 are arranged on opposite sides of the push-button 6. The two microswitches 11 are provided for redundancy. Switching of at least one of the microswitches 11 from an off-state to an on-state is considered as an indication of pushing of the push-button 6. However, the push-button arrangement could be provided with a single microswitch 11 or more than two microswitches 11. The microswitches 11 are arranged such that they are pushed in a direction that is parallel to the plane of the push-button panel 4. The push-button 6 is provided with an inclined guide surface 19. When the push-button 6 is pushed, the inclined guide surface 19 is configured to push the microswitch 11 in a direction that is perpendicular to the moving direction of the push-button 6. As the microswitches 11 are arranged such that they are operated in a direction that is parallel to the plane of the push-button panel 4, the push-button arrangement can be made thin. The spring plate 8 of the second embodiment is similar to the spring plate 8 of the first embodiment.

In the second embodiment, the push-button arrangement comprises a rear cover 20. The rear cover 20 is configured to retain the microswitches 11 between the push-button panel 4 and the rear cover 20. The push-button frame 21 of the arrangement is similar to the push-button frame 21 of the first embodiment. In the embodiment of the figures, the rear cover 20 is attached to the push-button panel 4 by means of screws.

Instead of using the two microswitches 12 of the second embodiment to provide redundancy, the two microswitches 12 could be configured to detect how the push-button 6 has been pressed. If the push-button 6 is pressed in the middle of the push-button 6, the state of the two microswitches 12 is switched substantially at the same time. If the push-button 6 is pressed close to an edge where one of the microswitches 12 is located, only the respective microswitch 12 may be switched on or it may switch on before the other microswitch 12. Switching of the both microswitches 12 within a predetermined period of time can thus be interpreted as an indication that the push-button 6 was pressed in the middle of the push-button 6. If only one of the microswitches 12 is switched on or the time interval between the switching of the two microswitches 12 is above a predetermined threshold, it can be interpreted to indicate that one of the edges of the push-button 6 was pressed. The two microswitches 12 could thus allow using three different functions of the gaming machine 1 by pressing the push-button 6 in different ways.

FIG. 12 shows one optional feature of the push-button arrangement. In the embodiment of FIG. 12, the free end of each spring element 7 is provided with an opening 9. The push-button 6 is provided with a corresponding number of guide elements 10 that are configured to protrude into the openings 9 of the spring elements 7. The arrangement limits moving of the push-button 6 in the plane of the push-button panel 4. It is not necessary to provide all the spring elements 7 with the openings 9, but it would be sufficient to provide only some of the spring elements 7 with the openings 9. For instance, openings 9 could be arranged in the spring elements 7 in opposite corners of the push-button 6. The openings 9 and the guide elements 10 allow making the gap between the push-button 6 and the push-button panel 4 smaller without a risk of the push-button 6 being pulled to sides when being pushed.

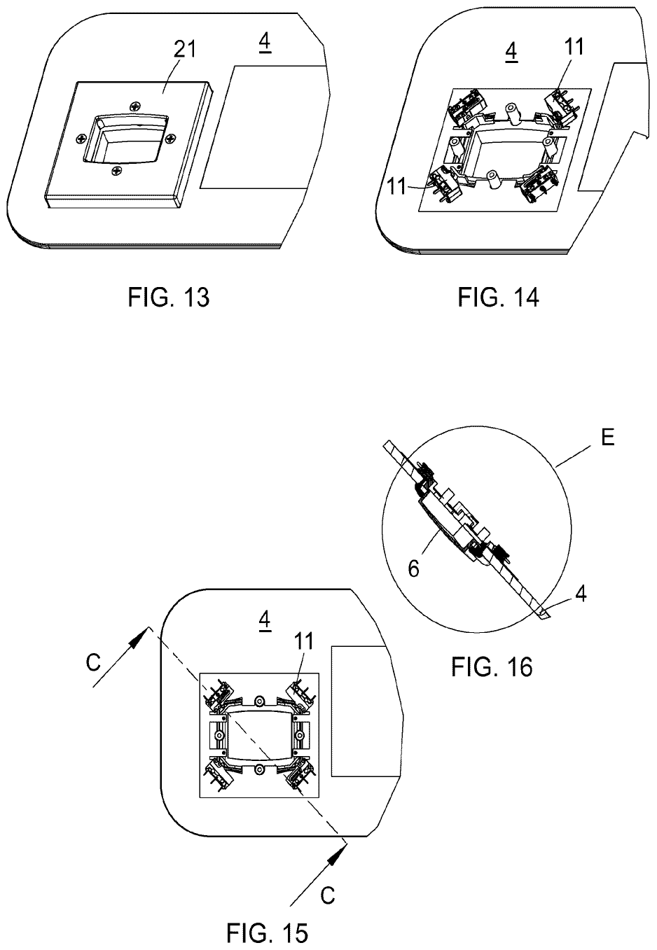

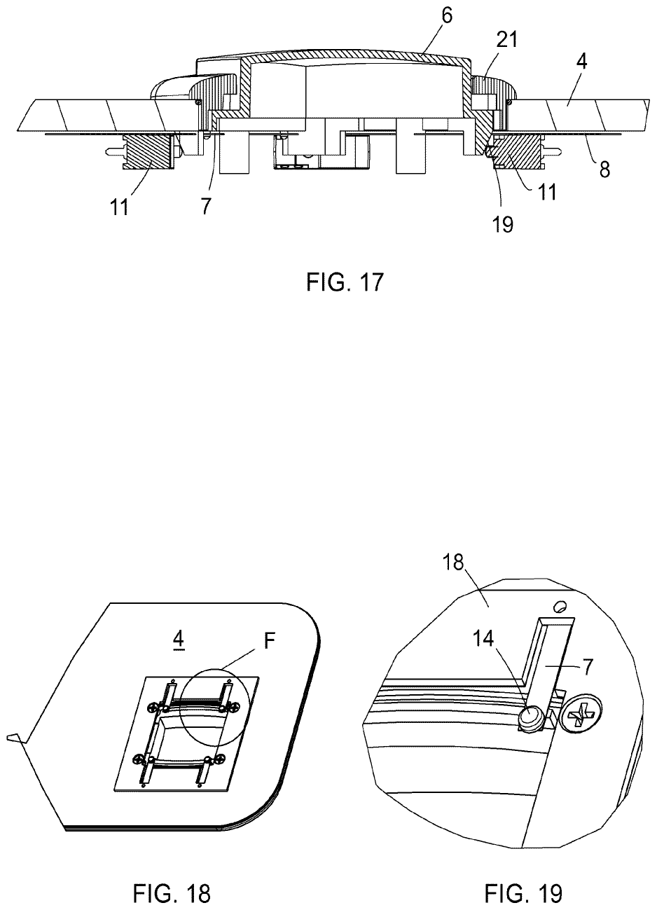

FIGS. 13 to 17 show a push-button arrangement according to a third embodiment of the invention. The push-button arrangement according to the third embodiment is similar to the second embodiment. However, the arrangement is provided with four microswitches 11. The push-button 6 is substantially rectangular, and each microswitch 11 is arranged close to one of the corners of the push-button 6. When the push-button 6 is pressed at a corner area, only the closest microswitch 11 is switched on or at least the closest microswitch 11 is switched on before the other microswitches 11. If the push-button 6 is pressed at an edge area in the middle of two corners, only two of the microswitches 11 are switched on or those are switched on before the other two microswitches 11. If the push-button 6 is pressed in the middle of the push-button 6, all the four microswitches 11 are switched on substantially at the same time. This allows detecting how the push-button 6 has been pushed and different functions can be activated depending on which area of the push-button 6 has been pressed. As an example, if the push-button 6 is pressed gently and close enough to a corner, only one of the microswitches 11 may be switched on. If the push-button 6 is pressed harder and/or farther from the corner, also another microswitch 11 may be switched on. If the time interval between the switching of the two microswitches 11 is above a predetermined threshold, such as 3 milliseconds, it can be interpreted that the user intended pressing the corner where the microswitch 11 was switched on first. If two microswitches 11 are switched on within a predetermined time interval, it can be interpreted that the user intended to press an edge of the push-button 6 between two corners of the push-button 6. If four microswitches 11 are switched on within a predetermined time interval, it can be interpreted that the user intended to press the middle region of the push-button 6.

The push-button arrangement can be configured to allow using up to nine different functions. Pressing the push-button 6 at each of the four corners corresponds to four different functions. Pressing the push-button 6 in the middle of each of the four edges corresponds to four further functions. Pressing the push-button 6 in the middle of the push-button 6 corresponds to one more function.

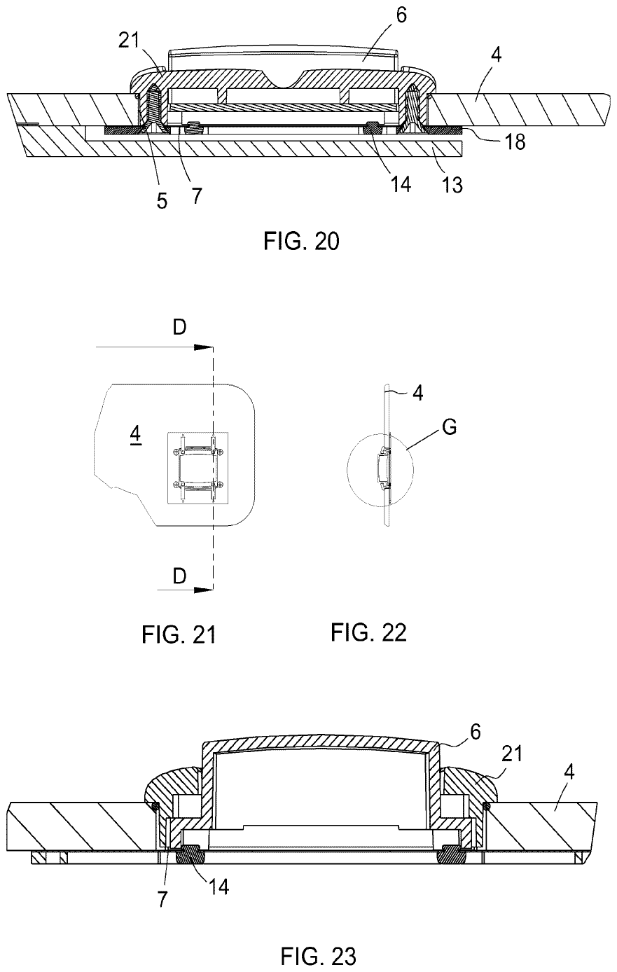

FIGS. 20 to 23 show a push-button arrangement according to a fourth embodiment of the invention. In the fourth embodiment, the free end of each spring element 7 is provided with a contact element 14. A contact surface 13 is arranged below the push-button 6. As the push-button 6 is pushed, the contact elements 14 contact the contact surface 13 and indicate pushing of the push-button 6. The contact surface 13 could be implemented in many different ways, for instance as a circuit board or a touch-sensitive film. The contact surface 13 could also be a touch display. Instead of arranging the contact elements 14 in the spring elements 7, the contact elements 14 could be arranged in the push-button 6. The push-button arrangement according to the fourth embodiment can be configured in a similar way as the first and third embodiments to detect which area of the push-button 6 is pressed. The contact surface 13 can be provided with a dedicated touch detection area for each of the contact elements 14. Based on which of the touch detection areas are touched by the contact elements 14 and/or in which order the touch detection areas are touched by the contact elements 14, it can be determined whether the push button 6 has been pressed in the middle of the push-button 6, near a corner of the push-button 6 or in the middle of one of the edges of the push-button 6.

In the embodiments of the figures, the push-button 6 is transparent. An optical block 24 is arranged within a space that is partly limited by the push-button 6. A display can be arranged below the optical block 24. The optical block 24 is configured to transmit light from the display to the push-button 6 to give an impression of the display being located just below the upper surface of the push-button 6. The display can be configured to display, for instance, different functions of the push-button 6. For instance, the display could show different pressing areas of the push-button 6.

It will be appreciated by a person skilled in the art that the invention is not limited to the embodiments described above, but may vary within the scope of the appended claims. For instance, if the push detection means comprise one or more electrical switches, the push-button arrangement could be configured such that switching of an electrical switch from an on-state to an off-state is an indication of pushing of the push-button.

1. A push-button arrangement for a gaming machine, the push-button arrangement comprising:
a push-button panel comprising at least one opening configured to receive a push-button;
a push-button disposed in the at least one opening of the push-button panel and having a rest position and at least one pushed position;
a push detector configured to detect moving of the push-button to the at least one pushed position; and
at least two bendable spring elements, each of the spring elements having a fixed end that is attached directly or indirectly to the push-button panel and a free end, wherein a force exerted on the free end in a direction that is perpendicular to the plane of the push-button panel causes bending of the spring element,
wherein the push-button arrangement is configured such that pushing of the push-button from the rest position to the at least one pushed position exerts the force on the respective free ends of the spring elements such that the spring elements are bent, and
the spring elements are configured to push the push-button back to the rest position when the push-button is released.

2. The push-button arrangement according to claim 1, wherein the spring elements are part of a spring plate.

3. The push-button arrangement according to claim 1, wherein the at least two bendable spring elements comprise at least four spring elements.

4. The push-button arrangement according to claim 1, wherein the spring elements are made of steel.

5. The push-button arrangement according to claim 1, wherein the free end of one or more of the at least two bendable spring elements comprises an opening, and
the push-button comprises a guide element protruding through the opening to limit movement of the push-button in the direction of the plane of the push-button panel.

6. The push-button arrangement according to claim 1, wherein the push detector comprises at least one electrical switch.

7. The push-button arrangement according to claim 1, wherein the push detector comprises at least one microswitch and pushing of the push-button is configured to push the microswitch in a direction that is parallel to the plane of the push-button panel.

8. The push-button arrangement according to claim 1, wherein at least one of the spring elements is configured to form part of an electrical switch functioning as the push detector.

9. The push-button arrangement according to claim 1, wherein the push detector comprises a touch detection surface disposed below the push-button and at least one contact element configured to contact the touch detection surface when the push-button is in the at least one pushed position.

10. The push-button arrangement according to claim 9, wherein the at least one contact element is attached to one of the spring elements.

11. The push-button arrangement according to claim 1, wherein the push detector comprises a touch-sensitive surface disposed below the push-button.

12. The push-button arrangement according to claim 1, wherein the push detector comprises a touch display disposed below the push-button.

13. The push-button arrangement according to claim 1, wherein the push detector is configured to detect which area of the push-button is pressed.

14. The push-button arrangement according to claim 13, wherein the push detector comprises at least two electrical switches or at least two touch detection areas, and switching of the states of the electrical switches or touching of the touch detection areas is configured to depend on which area of the push-button is pressed.

15. A gaming machine comprising the push-button arrangement according to claim 1.
